(19) United States
(12) Patent Application Publication
(10) Pub. No.: US 2006/0225584 A1
(43) Pub. Date: Oct. 12, 2006

(54) Fruit squeezer

(76) Inventor: Ruey-Lan Horng, Yung-Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/103,570

(22) Filed: Apr. 12, 2005

(51) Int. Cl. A23N 1/00

(52) U.S. Cl. 99/501

(57) ABSTRACT

The present invention relates to a fruit squeezer having a shallow container having a bottom on which a plurality of apertures and a protrudent device are mounted. More particularly, the present invention discloses a tunnel having an upward-facing opening. The tunnel is formed on the inside of the protrudent device for holding the fruit stem and preventing the fruit stem from interfering with the squeezing process. A threaded connecting base having a downward-facing opening is mounted under the shallow container. The threaded connecting base is designed to be a tube having a cross-section corresponding to the bottom of the protrudent device for being coupled with threads of a bottle such that the fruit juice can be directly and easily stored in the bottle.

### FIELD OF THE INVENTION

The present invention relates to a fruit squeezer, and more particularly to a tool for squeezing fruit juice out of the fruit.

### BACKGROUND OF THE INVENTION

Because of having nutrition and deliciousness, fruit has been become a kind of popular daily food for most people. Moreover, the fruit juice is obtained by several processing methods, for example, squeezing method, rapid cutting method, or water/additives mixing method, wherein the squeezing method is most commonly applied to orange and tangerine. The present invention also sets forth a fruit squeezer.

Referring to FIG. 1, the conventional fruit squeezer 1 comprises a shallow container 11. A plurality of apertures 111 are formed on the bottom of the shallow container 11, and a protrudent device 12 is mounted on the surface of the shallow container 11 for being inserted into a cross-section of the cut fruit. When the fruit is pressed on the protrudent device 12 by the applied force, the fruit juice is squeezed out of the fruit.

However, most fruits such as orange, tangerine, and lemon contain the fruit stems, which only provide a few fruit juice or fruit pulp, and which also interfere with the process of squeezing the other soft and dense fruit pulp. Accordingly, the fruit juice cannot be fully squeezed out of the fruit pulp.

Moreover, the bottom of the conventional fruit squeezer cannot couple with a bottle so the fruit juice, which is squeezed from the fruit, is generally first stored in a vessel. When there is a need to pour the fruit juice into the bottle, a funnel and the bottle must be prepared for the bottling process. Alternatively, another kind of fruit squeezer 1, as shown in FIG. 1, further comprises a large frame 13 on its bottom periphery for coupling the fruit squeezer 1 to an external container (not shown). However, because of having large size the external container is not suitable for being carried outside. If there is a need to pour the fruit juice into a bottle, a funnel and the bottle still must be prepared for the bottling process. Accordingly, the bottling process is too complicated.

### SUMMARY OF THE INVENTION

In view of the aforementioned problems of the conventional structures, the present inventor contemplates providing an improved structure of a fruit squeezer. The fruit squeezer comprises a shallow container having a bottom on which a plurality of apertures and a protrudent device are mounted. More particularly, the present invention discloses a tunnel having an upward-facing opening. The tunnel is formed on the inside of the protrudent device for holding the stem of the fruit and preventing the stem from interfering with the squeezing process.

A threaded connecting base having a downward-facing opening is mounted under the shallow container. The threaded connecting base is designed for coupling the fruit squeezer to the threads of a bottle so that the fruit juice can be directly and easily stored in the bottle.

### BRIEF DESCRIPTION OF THE DRAWINGS

FIG. 1 is an elevational view showing a conventional fruit squeezer.

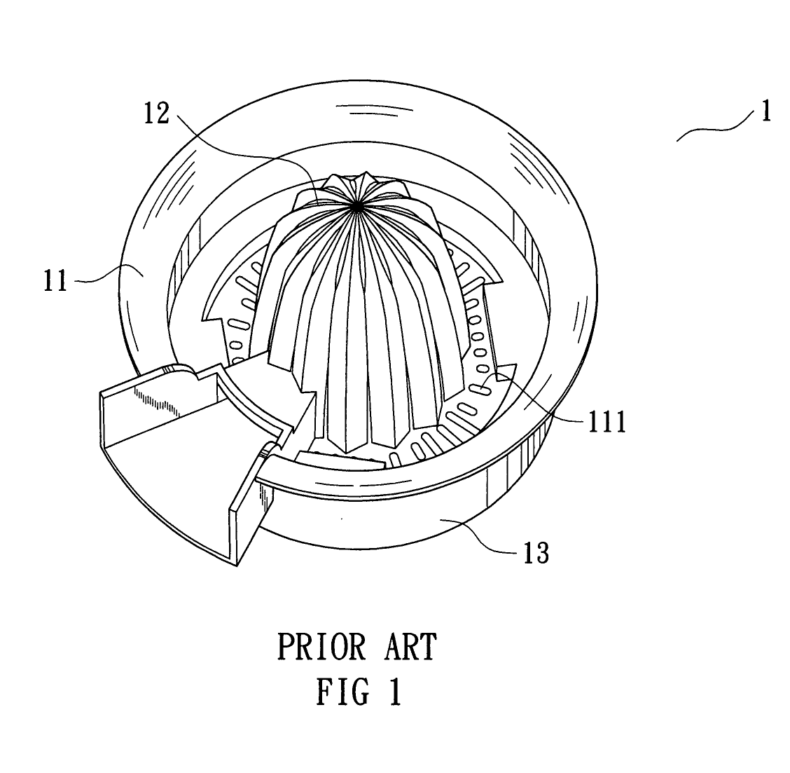

FIG. 2 is an elevational view showing a fruit squeezer of the present invention.

FIG. 3 is a cross-sectional view taken on line A-A of FIG. 2.

FIG. 4 is a schematic plan view showing that the fruit squeezer is cooperated with the fruit and the bottle (feeding bottle) in accordance with the present invention.

FIG. 5 is a schematic elevational view showing that the fruit squeezer is cooperated with the bottle (feeding bottle) in accordance with the present invention.

FIG. 6 is a schematic plain view showing that the gasket is coupled with the fruit squeezer in accordance with the present invention.

FIG. 7 is a schematic elevational view showing that the fruit squeezer is cooperated with the PET bottle in accordance with the present invention.

### DETAILED DESCRIPTION OF THE PREFERRED EMBODIMENT

The description taken with the drawings make the structures, features, and embodiments of the present invention apparent to those skilled in the art how the present invention may be embodied in practice.

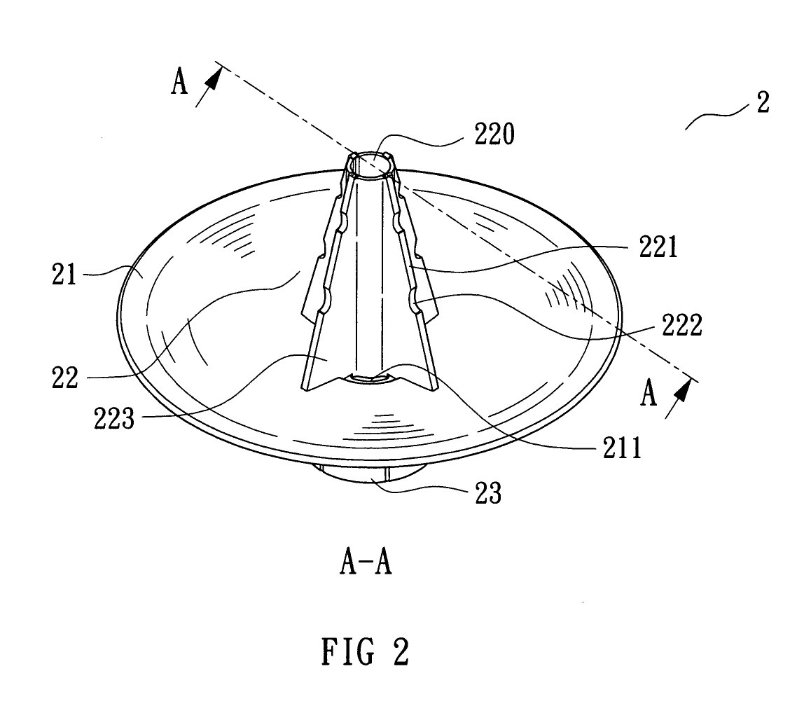

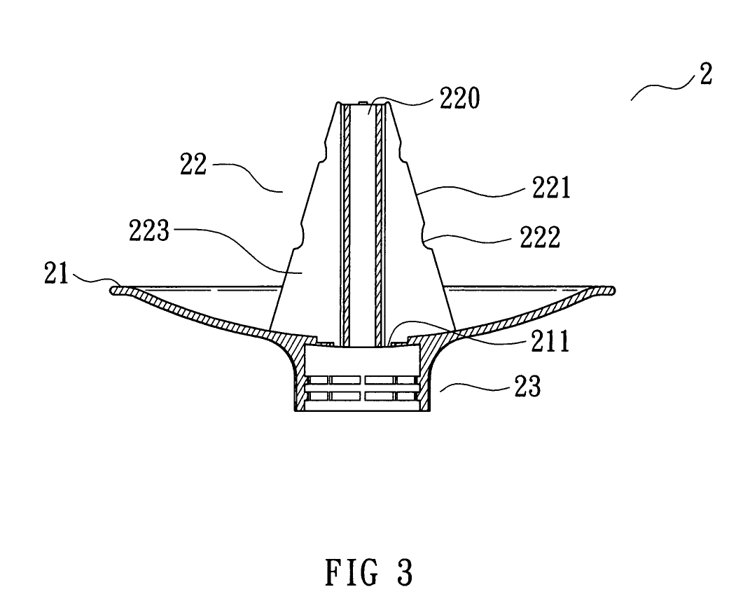

Referring to FIG. 2 and FIG. 3, the present invention pertains to a fruit squeezer 2. The fruit squeezer 2 comprises a shallow container 21, a protrudent device 22, and a threaded connecting base 23.

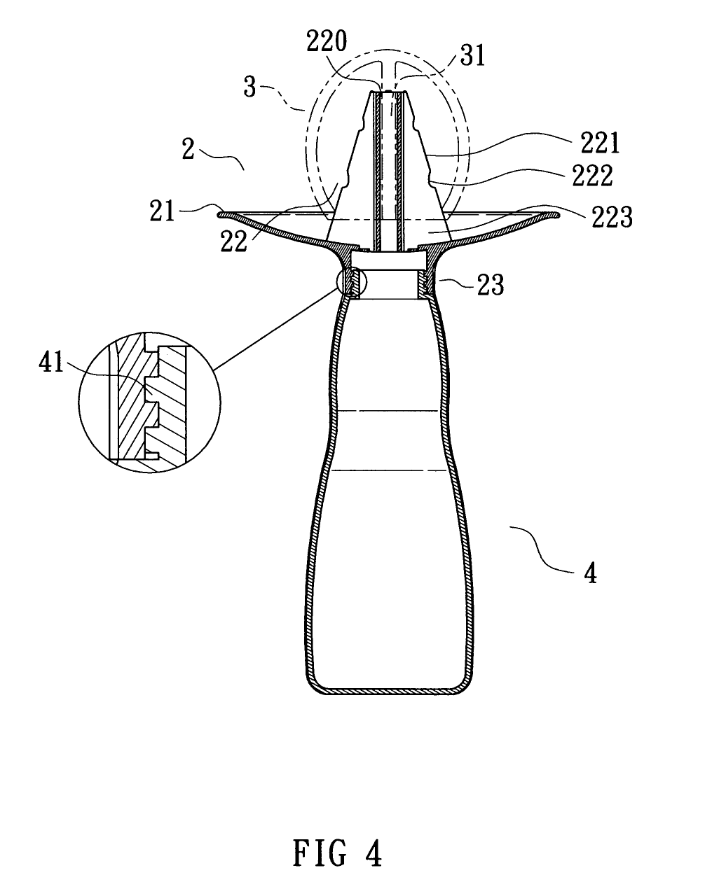

As shown in FIG. 4, the shallow container 21 is designed for holding the fruit 3, which is cut off partially. Besides, a plurality of apertures 211 are formed on the bottom of the shallow container 21 for allowing the fruit juice to flow through the shallow container 21.

The protrudent device 22 is mounted on the surface of the shallow container. A plurality of gradually downward broadened ribs 223 are distributed over the periphery of the protrudent device 22 so the protrudent device 22 has a gradually downward broadened outline to match the partially cut fruit 3, thereby providing the downward increased pressing force for the fruit 3 and improving the squeezing result.

A tunnel 220 having an upward-facing opening is formed on the inside of the protrudent device 22 for holding the stem 31 of the fruit 3. It is worthy to note that the fruit stem 31 only provides a few fruit juice or fruit pulp, and the fruit stem 31 also interferes with the process of squeezing the fruit juice from the soft and dense pulp tissues of the fruit 3. Accordingly, the tunnel 220 of the protrudent device 22 that holds the stem 31 of the fruit 3 during the squeezing process can prevent it from interfering with the squeezing process.

A plurality of protrudent teeth 221 are mounted at intervals on the outside of the protrudent device 22, and a notch 222 is defined by every two adjacent teeth 221. These notches 222 are designed for providing the shearing force for destroying the pulp tissues during the squeezing and rotating process. Accordingly, the fruit juice can be fully squeezed out of the fruit pulp.

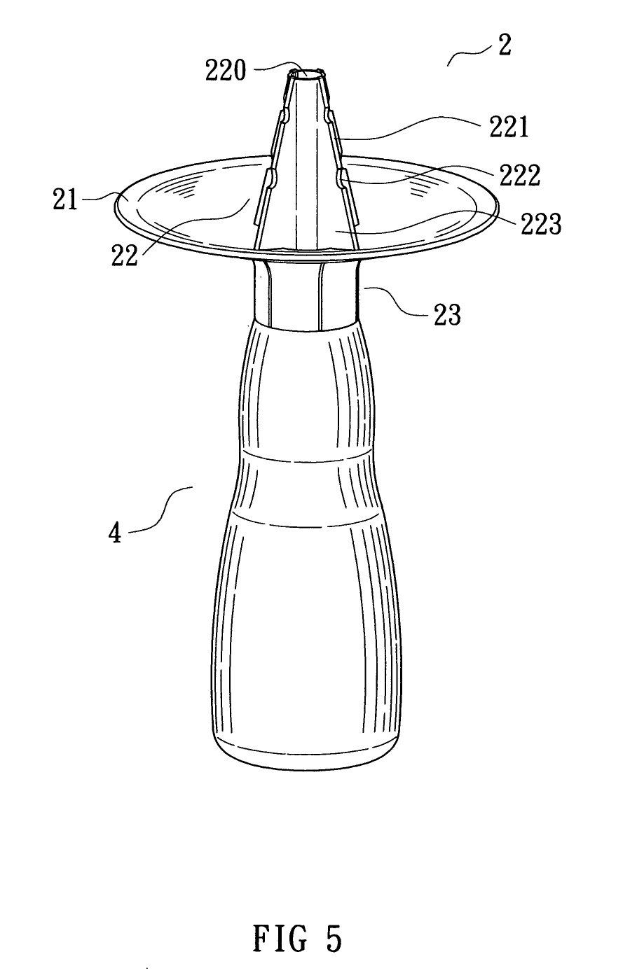

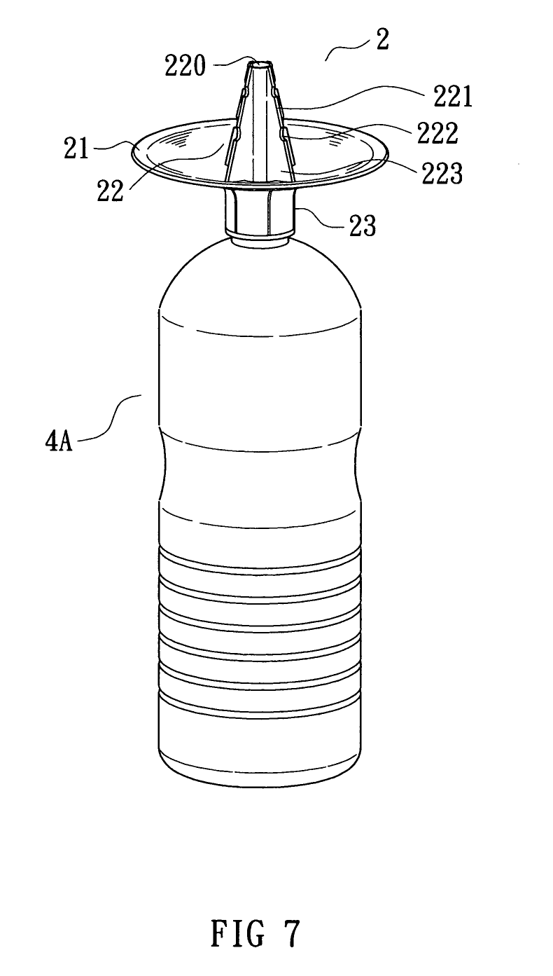

A threaded connecting base 23 having a downward-facing opening is mounted under the shallow container 21. The threaded connecting base 23 is designed to be a tube having a cross-section corresponding to the bottom of the protrudent device 22 for being coupled with threads 41 of a bottle 4 (shown in FIG. 4) so that the fruit juice can be stored in the bottle 4 directly. Besides, the bottle 4 is such as a feeding bottle (shown in FIG. 4 and FIG. 5) or a general PET (polyethylene terephthalate) bottle 4A (shown in FIG. 7).

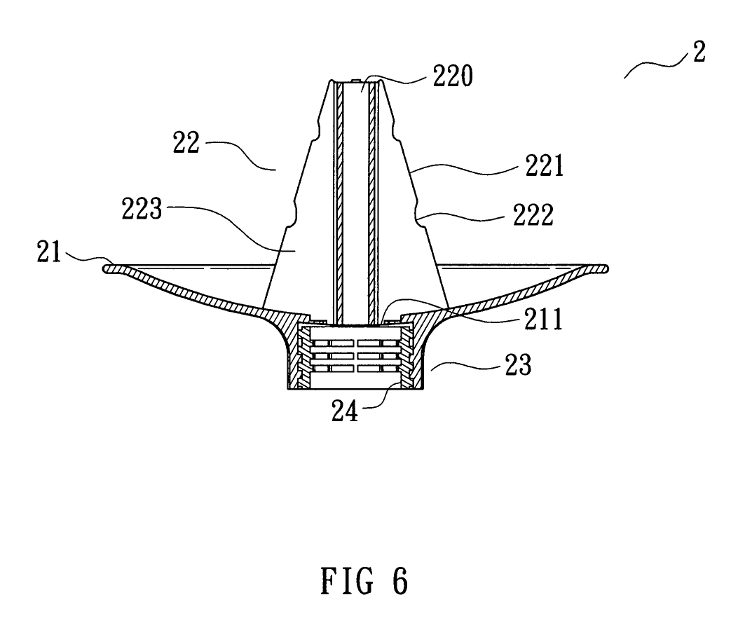

Referring further to FIG. 6, a gasket 24 may be mounted on the inside of the threaded connecting base 23 and screwed thereon by use of its outer edge. The gasket 24 is designed to have an inner edge corresponding to the bottle having a smaller outer diameter size. Accordingly, the fruit squeezer of the present invention is adjustable and can be widely applied to various bottles having various outer diameter sizes.

The present invention provides the following efficacy and advantage, in which:

1. The tunnel having the upward-facing opening is formed on the inside of the protrudent device for holding the fruit stem and preventing the fruit stem from interfering with the squeezing process.

2. The gradually downward broadened ribs are distributed over the periphery of the protrudent device so the protrudent device has a gradually downward broadened outline to match the partially cut fruit, thereby providing the downward increased pressing force for the fruit and improving the squeezing result.

3. The protrudent teeth are mounted at intervals on the outside of the protrudent device, and a notch is defined by every two adjacent teeth. The notch is designed for providing the shearing force for destroying the pulp tissues during the squeezing and rotating process. Accordingly, the fruit juice can be fully squeezed out of the fruit pulp.

4. The threaded connecting base having a downward-facing opening is mounted under the shallow container. The threaded connecting base is designed to be a tube having a cross-section corresponding to the bottom of the protrudent device for being coupled with the threads of the bottle such that the fruit juice can be directly and easily stored in the bottle.

5. The gasket may be mounted on the inside of the threaded connecting base and screwed thereon by use of its outer edge. The gasket is designed to have an inner edge corresponding to the bottle having a smaller outer diameter size. Accordingly, the fruit squeezer of the present invention is adjustable and can be widely applied to various bottles having various outer diameter sizes.

On the basis of the description mentioned above, the present invention indeed satisfies requirements for patentability, and is therefore submitted for a patent.

With the invention thus explained, it is apparent that various modifications and variations can be made without departing from the scope of the invention. It is therefore intended that the invention be limited only as indicated in the appended claims.

1. A fruit squeezer having comprising:
a shallow container having a bottom with a plurality of apertures being formed therethrough; and,
a protrudent device extending longitudinally from said shallow container, said protrudent device having a longitudinally directed tunnel formed therein, said tunnel having an opening formed on an upper end thereof and a closed bottom end for holding a fruit stem therein, said protrudent device having a plurality of radially extending ribs, each of said ribs having an inclined distal edge with a plurality of longitudinally spaced and radially directed teeth formed thereon.

2. The fruit squeezer of claim 1, wherein each of the plurality of ribs have a notch formed therein between each respective pair of said teeth.

3. The fruit squeezer of claim 1, further comprising:
a threaded base extending from a bottom side of said shallow container and having a central opening in fluid communication with said apertures, said threaded base having an annular wall with threads formed on an inner side thereof of for coupling to a bottle havinig external threads corresponding thereto; and,
a gasket member having an annular wall with first threads formed on an external surface thereof for threaded engagement with said threads of said threaded base, said gasket member having second threads formed on an internal surface of said annular wall for coupling with a bottle having a different size threaded opening than corresponding to said threads of said threaded base.

4. A fruit squeezer comprising:
a shallow container having a bottom with a plurality of apertures being formed therethrough;
a threaded base extending from a bottom side of said shallow container and having a central opening in fluid communication with said apertures, said threaded base having an annular wall with threads formed on an inner side thereof of for coupling to a bottle, having external threads corresponding thereto;
a protrudent device extending longitudinally from said shallow container, said protrudent device having a plurality of radially extending ribs, each of said ribs having an inclined distal edge with a plurality of longitudinally spaced and radially directed teeth formed thereon; and,
a gasket member having an annular wall with first threads formed on an external surface thereof for threaded engagement with said threads of said threaded base, said gasket member having second threads formed on an internal surface of said annular wall for coupling with a bottle having a different size threaded opening than corresponding to said threads of said threaded base.

5-6. (canceled)
